(19) United States
(12) Patent Application Publication
(10) Pub. No.: US 2025/0070138 A1
(43) Pub. Date: Feb. 27, 2025

(54) NEGATIVE ELECTRODE MATERIAL OF LITHIUM ION SECONDARY BATTERY, PREPARATION METHOD THEREOF AND USE THEREOF

(71) Applicant: BTR NEW MATERIAL GROUP CO., LTD., Shenzhen (CN)

(72) Inventors: Lijuan QU, Shenzhen (CN); Chunlei PANG, Shenzhen (CN); Jianguo REN, Shenzhen (CN); Youyuan HUANG, Shenzhen (CN); Min YUE, Shenzhen (CN)

(21) Appl. No.: 18/941,450

(22) Filed: Nov. 8, 2024

Related U.S. Application Data
(63) Continuation-in-part of application No. 17/042,640, filed on Sep. 28, 2020, now Pat. No. 12,166,210.

(30) Foreign Application Priority Data
Sep. 28, 2018 (CN) 201811138477.0

(51) Int. Cl. H01M 4/36; C01B 33/113; H01M 4/48; H01M 4/58; H01M 4/587

(52) U.S. Cl. CPC H01M 4/366; C01B 33/113; H01M 4/48; H01M 4/5825; H01M 4/587; C01P 2002/72; C01P 2004/03; C01P 2004/80; C01P 2006/40

(57) ABSTRACT

A negative electrode material of a lithium ion secondary battery includes a carbon coating layer and a core layer. The core layer comprises lithium polysilicate and silicon oxide. A preparation method for the negative electrode material and a use therefor are described. The negative electrode material has high first coulomb efficiency, long cycle performance, excellent rate performance, and high safety.

### CROSS-REFERENCE TO RELATED APPLICATIONS

The present application is a continuation-in-part of U.S. patent application Ser. No. 17/042,640, filed on Sep. 28, 2020, with the title of “NEGATIVE ELECTRODE MATERIAL OF LITHIUM ION SECONDARY BATTERY, PREPARATION METHOD THEREOF AND USE THEREOF”, which is a national phase of International Application No. PCT/CN2019/098882, filed on Aug. 1, 2019, and claims priority to Chinese Patent Application No. 201811138477.0, filed on Sep. 28, 2018, each of which are incorporated herein by reference in their entireties.

### TECHNICAL FIELD

The present application relates to the field of lithium ion batteries, and particularly, to a negative electrode material of a lithium ion secondary battery, a preparation method thereof, and a use thereof.

### BACKGROUND

Lithium ion secondary batteries are widely used in portable electronic products, electric vehicles, and energy storage, etc. due to its high quality, high volumetric energy density, long cycle, and low self-discharge performance. However, a combination of the conventional graphite and electrode plate is far from meeting the market demand. Although the existing SiC can reach a theoretical capacity as high as 4200 mAh/g, its expansion is up to 300%, which negatively affects the cycle performance and limits promotion in the market and application thereof. In contrast, silicon oxide materials have better cycle performance, but the first efficiency is low. During the first charge, 20-50% of lithium is consumed to form SEI film, which greatly reduces the first coulomb efficiency. As the first coulomb efficiency (first efficiency) of the positive electrode material becomes higher and higher, it becomes particularly important to improve the first efficiency of the silicon oxide materials.

In order to improve the first efficiency of the silicon oxide materials, intensive researches have been conducted among enterprises, universities, and scientific research institutions. Currently, a common approach for improving the first efficiency is to reduce the oxygen content in the silicon oxide materials and thus to increase a ratio of silicon to oxygen using aluminothermic or magnesiothermic reduction methods. Another common approach is to directly dope lithium, for example, an industrialized method in which a lithium layer is directly coated on the surface of the electrode plate to reduce the lithium consumption of the positive electrode.

### SUMMARY

The following is a summary of subject matters described in detail in the present application. The summary is not intended to limit the protection scope of the claims.

The present application provides a negative electrode material of a lithium ion secondary battery, a preparation method thereof and a use thereof. The negative electrode material has high first coulomb efficiency, long cycle life, excellent rate performance and high safety.

For the above objects, the present application adopts the following technical solutions.

A first object of the present application is to provide a negative electrode material of a lithium ion secondary battery, and the negative electrode material includes a carbon coating layer and a core layer. The core layer includes lithium polysilicate and silicon oxide.

In some embodiments, the lithium polysilicate includes any one of or a combination of at least two of 3Li₂O·2SiO₂, Li₂O·2SiO₂, or Li₂O·5SiO₂, and typical examples of the combination includes, but not limited to, a combination of 3Li₂O·2SiO₂ and Li₂O·2SiO₂, a combination of Li₂O·2SiO₂ and Li₂O·5SiO₂, a combination of Li₂O·5SiO₂ and 3Li₂O·2SiO₂, and a combination of 3Li₂O·2SiO₂, Li₂O·2SiO₂ and Li₂O·5SiO₂, etc.

As Li₂SiO₃, Li₄SiO₄ and other lithium silicates commonly used in the prior art are easily dissolvable in water, the performance of the material may deteriorate during a slurry preparation process in the water system. The core layer of the negative electrode material of a lithium ion secondary battery according to the present application is lithium polysilicate, which avoids the performance deterioration that may occur in the above-mentioned slurry preparation process in the water system.

In some embodiments, the negative electrode material satisfies 1.0≤B/A≤4.5, where according to a X-ray diffraction spectrum of the negative electrode material, a maximum one of diffraction peaks at 2θ of 18° to 20°, 26° to 27.9°, and 32° to 34° has a peak intensity A; and a maximum one of diffraction peaks at 2θ of 16° to 17°, 22° to 25.9°, and 36° to 38° has a peak intensity B.

The B/A of the negative electrode material represents an equilibrium level between lithium polysilicate Li₂O·2SiO₂ and other lithium silicates. The different lithium silicates involve different contributions on the performance of negative electrode material, especially on processing performance, capacity, and first efficiency. By numerous experiments, it found that through controlling the equilibrium level between lithium polysilicate Li₂O·2SiO₂ and other lithium silicates within 1.0 to 4.5, the negative electrode material not only has a longer storage after preparing to a slurry, but also has higher capacity and first efficiency. Specifically, the presence of lithium polysilicate Li₂O·2SiO₂ facilitates to improve storage performance and specific capacity of the slurry, while the other lithium silicates facilitate to enhance first efficiency of the negative electrode material. If the equilibrium level is less than 1, indicating that lithium silicate Li₂O·2SiO₂ has a relatively low amount in the negative electrode material, while the other lithium silicates are excessive more. The resulted material has a high first efficiency, but a low capacity, a serious processing problem, and a poor slurry storage performance, thus fails to be employed normally. If the equilibrium level is greater than 4.5, indicating that lithium silicate Li₂O·2SiO₂ has a relatively high amount in the negative electrode material, while the other lithium silicates are too little. The resulted material has a high capacity and a good storage performance, but a low first efficiency, a small applicable range, and a limited energy density of the battery.

In some embodiments, in the core layer, the lithium polysilicate comprises silicon therein.

In some embodiments, the lithium polysilicate is in a crystalline state.

In some embodiments, the silicon oxide has a general formula of SiOₓ, where 0<x≤1.5, for example, x may be, but not limited to, 0.01, 0.1, 0.2, 0.3, 0.4, 0.5, 0.6, 0.7, 0.8, 0.9, 1.0, 1.1, 1.2, 1.3, 1.4, or 1.5, etc. Other values within such a range but not mentioned are also suitable.

In some embodiments, a mass percentage of the silicon oxide in the negative electrode material is smaller than 20%, for example, but not limited to, 19%, 18%, 17%, 16%, 15%, 12%, 10%, or 5%, etc. Other values within such a range but not mentioned are also suitable. If the silicon oxide is completely consumed in reaction, the capacity may be significantly reduced; similarly, if too much of the silicon oxide is remained, the first efficiency may be less improved.

In some embodiments, a mass percentage of the carbon coating layer in the negative electrode material is smaller than 13%, for example, but not limited to, 12%, 11%, 10%, 8%, 5%, 3%, 2%, or 1%, etc. Other values within such a range but not mentioned are also suitable.

A second object of the present application is to provide a preparation method of the negative electrode material mentioned above. The method includes:
step 1 of mixing a silicon oxide raw material with a lithium source compound, and performing merging in a high-energy merging device, to obtain silicon oxide particles containing the lithium source compound therein;
step 2 of performing a first sintering on the silicon oxide particles containing the lithium source compound therein, which are obtained in the step 1, under a protective atmosphere or vacuum, to obtain the core material; and
step 3 of mixing the core material obtained in the step 2 with a carbon source, and performing a second sintering to obtain the negative electrode material.

In some embodiments, the silicon oxide raw material has a general formula of SiO_{y}, where 0<y≤2, for example, y may be, but not limited to, 0.01, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2 etc. Other values within such a range but not mentioned are also suitable.

In some embodiments, in the step 1, a molar ratio of the silicon oxide raw material to the lithium source compound is (2.5-9):1, for example, but not limited to, 2.5:1, 3:1, 3.5:1, 4:1, 5:1, 6:1, 7:1, 8:1, or 9:1, etc. Other values within such a range but not mentioned are also suitable.

In some embodiments, the first sintering in the step 2 includes a first stage and a second stage.

In some embodiments, the first stage is performed at a temperature of 200° C. to 1000° C., for example, but not limited to, 200° C., 300° C., 400° C., 500° C., 600° C., 700° C., 800° C., 900° C., or 1000° C., etc. Other values within such a range but not mentioned are also suitable. An optional rang is 500° C. to 900° C.

In some embodiments, the first stage is performed for a time period of 1 h to 3 h, for example, but not limited to, 1 h, 1.2 h, 1.5 h, 1.8 h, 2 h, 2.2 h, 2.5 h, 2.8 h, or 3 h, etc. Other values within such a range but not mentioned are also suitable.

In some embodiments, the second stage is performed at a temperature of 300° C. to 900° C., for example, but not limited to, 300°° C., 400° C., 500° C., 600° C., 700° C., 800° C., or 900° C., etc. Other values within such a range but not mentioned are also suitable. An optional rang is 600° C. to 800° C.

In some embodiments, the second stage is performed for a time period of 4 h to 6 h, for example, but not limited to, 4 h, 4.2 h, 4.5 h, 4.8 h, 5 h, 5.2 h, 5.5 h, 5.8 h, or 6 h, etc. Other values within such a range but not mentioned are also suitable.

In some embodiments, the carbon source in the step 3 includes at least one of pitch, coal tar, polythiophene, polyolefin, sugar, polyhydric alcohol, and phenolic resin derivative, etc.

In some embodiments, in the step 3, a mass ratio of the core material to the carbon source is (0.03-0.15):1, for example, but not limited to, 0.03:1, 0.04:1, 0.05:1, 0.06:1, 0.07:1, 0.08:1, 0.09:1, 0.10:1, 0.11:1, 0.12:1, 0.13:1, 0.14:1, or 0.15:1, etc. Other values within such a range but not mentioned are also suitable.

In some embodiments, the second sintering in the step 3 is performed at a temperature of 800° C. to 1000° C., for example, but not limited to, 800° C., 820° C., 850° C., 880° C., 900° C., 920° C., 950° C., 980° C., or 1000° C., etc. Other values within such a range but not mentioned are also suitable.

In some embodiments, the second sintering in the step 3 is performed for a time period of 3 h to 6 h, for example, but not limited to, 3 h, 3.5 h, 4 h, 4.5 h, 5.5 h, or 6 h, etc. Other values within such a range but not mentioned are also suitable.

A third object of the present application is to provide another preparation method of the negative electrode material mentioned above. The preparation method includes:

step 1′ of mixing a silicon oxide raw material having a carbon coating layer with a lithium source compound, and performing merging in a high-energy merging device, to obtain carbon-coated silicon oxide particles containing the lithium source compound therein; and

step 2′ of performing sintering on the carbon-coated silicon oxide particles containing the lithium source compound therein, which are obtained in the step 1′, under a protective atmosphere or vacuum, to obtain the negative electrode material.

In some embodiments, the high-energy merging device can be a merging machine, a kneader or a high-energy ball mill, etc. The merging in the step 1 and the step 1′ is performed for a time period of 2 hours to 8 hours, for example, but not limited to, 2 h, 3 h, 4 h, 5 h, 6 h, 7 h, or 8 h, etc. Other values within such a range but not mentioned are also suitable.

In some embodiments, the lithium source compound in the step 1 and the step 1′ is a lithium-containing compound that is alkaline or/and reductive, for example, lithium hydroxide, lithium amide, lithium carboxylate, lithium hydride, lithium aluminum hydride, etc.

In some embodiments, in the step 1′, a molar ratio of the silicon oxide raw material having the carbon coating layer to the lithium source compound is (2.5-9):1, for example, but not limited to, 2.5:1, 3:1, 3.5:1, 4:1, 5:1, 6:1, 7:1, 8:1, or 9:1, etc. Other values within such a range but not mentioned are also suitable.

In some embodiments, the sintering in the step 2′ includes a first stage and a second stage.

In some embodiments, the first stage is performed at a temperature of 200° C. to 1000° C., for example, but not limited to, 200° C., 300° C., 400° C., 500° C., 600° C., 700° C., 800° C., 900° C., or 1000° C., etc. Other values within such a range but not mentioned are also suitable. An optional rang is 500° C. to 900° C.

In some embodiments, the first stage is performed for a time period of 3 h to 8 h, for example, but not limited to, 3 h, 4 h, 5 h, 6 h, 7 h, or 8 h, etc., etc. Other values within such a range but not mentioned are also suitable.

In some embodiments, the second stage is performed at a temperature of 300° C. to 900° C., for example, but not limited to, 300° C., 400° C., 500° C., 600° C., 700° C., 800° C., or 900° C., etc. Other values within such a range but not mentioned are also suitable. An optional rang is 600° C. to 800° C.

In some embodiments, the second stage is performed for a time period of 4 h to 10 h, for example, but not limited to, 4 h, 5 h, 6 h, 7 h, 8 h, 9 h, or 10 h, etc. Other values within such a range but not mentioned are also suitable.

In some embodiments, the protective atmosphere in the step 2 and the step 2′ is selected from the group consisting of nitrogen, helium, neon, argon, krypton, xenon, and combinations thereof. Typical examples of the combinations include, but not limited to, a combination of nitrogen and helium, a combination of helium and neon, a combination of neon and argon, a combination of argon and xenon, a combination of xenon and krypton, a combination of nitrogen, helium and argon, etc.

In some embodiments, the silicon oxide raw material having a carbon coating layer has a carbon content of 2 wt % to 10 wt %, for example, but not limited to, 2 wt %, 2.5 wt %, 3 wt %, 3.5 wt %, 4 wt %, 4.5 wt %, 5 wt %, 5.5 wt %, 6 wt %, 6.5 wt %, 7 wt %, 7.5 wt %, 8 wt %, 8.5 wt %, 9 wt %, 9.5 wt %, or 10 wt %, etc. Other values within such a range but not mentioned are also suitable.

In some embodiments, the silicon oxide raw material in the silicon oxide raw material having a carbon coating layer has a general formula of SiO_{y}, where 0<y≤1.5, for example, y may be, but not limited to, 0.01, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 2 etc. Other values within such a range but not mentioned are also suitable.

In some embodiments, after the step 3 or the step 2′, the preparation method further includes: breaking up, screening and demagnetizing the obtained negative electrode material.

A fourth object of the present application is to provide a lithium ion secondary battery, and a negative electrode of the lithium ion battery is prepared with the negative electrode material of a lithium ion secondary battery according to the present application.

In some embodiments, a silicon oxide raw material is selected as the precursor, and the reductive or alkaline lithium compound is used as the lithium source. The irreversible lithium-consuming phase in the silicon oxide raw material is converted into lithium polysilicate in advance, and silicon particles are generated at the same time. After sintering with the carbon source, the composite negative electrode material is obtained, which includes polysilicate and silicon oxide, silicon embedded in the lithium polysilicate and/or in the silicon oxide, and carbon coated on the surface thereof. Alternatively, the coating layer may be coated on the silicon oxide raw material in advance, then the silicon oxide raw material having a carbon coating layer reacts with the lithium source. In the negative electrode material, the lithium polysilicate is uniformly coated around each cluster of silicon particles, the lithium polysilicate (with a density of about 2.12 g/cm³) is denser than Li₁₅Si₄ (with a density of 1.18 g/cm³). The lithium-silicon alloy produced during charging is surrounded by the lithium polysilicate, which acts as a buffering layer to effectively buffer volume change generated during this process, thereby prolonging the cycle life of the material. Moreover, the lithium polysilicate has good lithium ion conductivity, which can ensure that lithium ions are smoothly intercalated/de-intercalated, providing good rate performance.

Compared with the prior art, the present application at least has the following beneficial effects.

For the negative electrode material of the lithium ion secondary battery, the preparation method thereof and the use thereof provided in the present application, the negative electrode material has a high first coulomb efficiency up to 90% or greater, a first discharge specific capacity up to 1700 mAh/g or greater, long cycle performance, a retention rate after 50 cycles up to 88% or greater, excellent rate performance, and high safety.

Other aspects will be clear upon reading and understanding the detailed description with reference to accompanying drawings.

### BRIEF DESCRIPTION OF DRAWINGS

FIG. 1 is an SEM image of a negative electrode material of a lithium ion secondary battery prepared in Example 1; and

FIG. 2 is an SEM image of a negative electrode material of a lithium ion secondary battery prepared in Example 5.

FIG. 3 is XRD patterns of a negative electrode material of a lithium ion secondary battery prepared in Example 6, where (A) is the XRD pattern at 2θ of 18.0 to 20.0; and (B) is the XRD pattern at 2θ of 22.0 to 25.5.

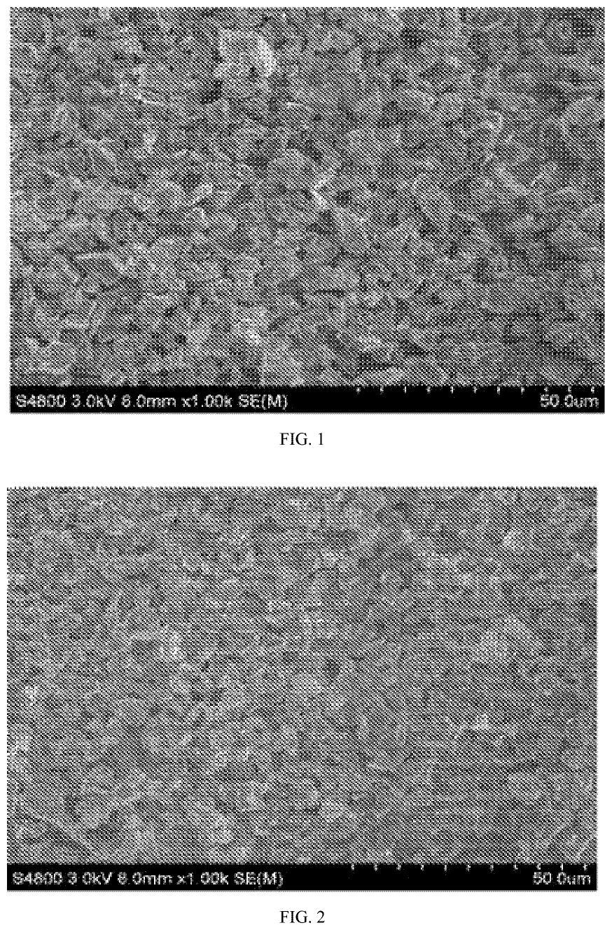

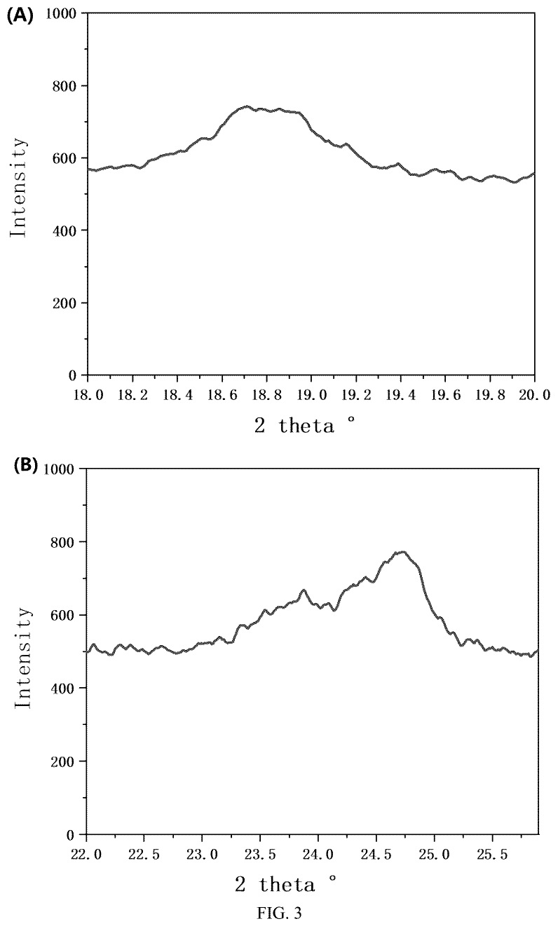

The present application is described in further detail below. However, the following examples are only simple examples of the present application, which do not represent or limit the protection scope of the present application. The protection scope of the present application is subject to the claims.

### DESCRIPTION OF EMBODIMENTS

In order to better explain the present application and facilitate the understanding of the technical solutions of the present application, typical but non-limiting examples of the present application are as follows.

### Example 1

(1) 50 g of silicon oxide raw material (SiO_{y}, y=1) having a carbon coating layer (carbon content: 3.5 wt %) and 11 g of LiOH were first uniformly mixed, and then placed into a high-energy merging device to be merged for 1 h, to obtain carbon-coated silicon oxide particles containing the lithium source compound therein; and

(2) Under the protection of nitrogen, the carbon-coated silicon oxide particles containing the lithium source compound therein obtained in step (1) were sintered at 700° C. for 3 hours, then further sintered at 800° C. for 4 hours, followed by cooling to room temperature by passing water, taken out, demagnetized and screened to obtain a finished product.

### Example 2

(1) 2000 g of silicon oxide raw material (SiO_{y}, y=1) having a carbon coating layer (carbon content: 3.5 wt %) and 44 g of SLMP were first uniformly mixed, and then placed into a high-energy merging device to be merged for 1 h, to obtain carbon-coated silicon oxide particles containing the lithium source compound therein; and

(2) Under the protection of argon, the carbon-coated silicon oxide particles containing the lithium source compound therein obtained in step (1) were sintered at 700° C. for 3 hours, then further sintered at 800° C. for 4 hours, followed by cooling to room temperature by passing water, taken out, demagnetized and screened to obtain a finished product.

### Example 3

(1) 50 g of silicon oxide raw material (SiO_{y}, y=1) having a carbon coating layer (carbon content: 3.5 wt %) and 11 g of LiOH were first uniformly mixed, and then placed into a high-energy merging device to be merged for 1 h, to obtain carbon-coated silicon oxide particles containing the lithium source compound therein; and

(2) Under the protection of nitrogen, the carbon-coated silicon oxide particles containing the lithium source compound therein obtained in step (1) were sintered at 200° C. for 8 hours, then further sintered at 300° C. for 10 hours, followed by cooling to room temperature by passing water, taken out, demagnetized and screened to obtain a finished product.

### Example 4

(1) 2000 g of silicon oxide raw material (SiO_{y}, y=1) having a carbon coating layer (carbon content: 3.5 wt %) and 44 g of SLMP were first uniformly mixed, and then placed into a high-energy merging device to be merged for 1 h, to obtain carbon-coated silicon oxide particles containing the lithium source compound therein; and

(2) Under the protection of argon, the carbon-coated silicon oxide particles containing the lithium source compound therein obtained in step (1) were sintered at 1000° C. for 3 hours, then further sintered at 900° C. for 4 hours, followed by cooling to room temperature by passing water, taken out, demagnetized and screened to obtain a finished product.

### Example 5

(1) 50 g of silicon oxide raw material (SiO_{y}, y=1) and 11 g of LiOH were first uniformly mixed, and then placed into a high-energy merging device to be merged for 1 h, to obtain silicon oxide particles containing the lithium source compound therein;

(2) Under the protection of helium, the silicon oxide particles containing the lithium source compound therein obtained in step (1) were sintered at 700° C. for 3 hours, then further sintered at 800° C. for 4 hours, followed by cooling to room temperature by passing water, and taken out to obtain a core material; and

(3) The core material obtained in step (2), and glucose accounting for 16% by mass of the core material were mixed, then sintered at 900° C. for 4 hours, and cooled. The cooled material was demagnetized and screened to obtain a finished product.

### Example 6

(1) 50 g of silicon oxide raw material (SiO_{y}, y=1) and 11 g of stabilized lithium metal powder (SLMP) were first uniformly mixed, and then placed into a high-energy merging device to be merged for 1 h, to obtain silicon oxide particles containing the lithium source compound therein;

(2) Under the protection of helium, the silicon oxide particles containing the lithium source compound therein obtained in step (1) were sintered at 700° C. for 3 hours, then further sintered at 800° C. for 4 hours, and followed by cooling to room temperature by passing water, to obtain a core material; and

(3) The core material obtained in step (2), and glucose accounting for 16% by mass of the core material were mixed, then sintered at 900° C. for 4 hours, and cooled. The cooled material was demagnetized and screened to obtain a finished product.

### Example 7

(1) 50 g of silicon oxide raw material (SiO_{y}, y=1) and 11 g of LiOH were first uniformly mixed, and then placed into a high-energy merging device to be merged for 1 h, to obtain silicon oxide particles containing the lithium source compound therein;

(2) Under the protection of helium, the silicon oxide particles containing the lithium source compound therein obtained in step (1) were sintered at 200° C. for 1 hour, then further sintered at 300° C. for 6 hours, followed by cooling to room temperature by passing water, and taken out to obtain a core material; and

(3) The core material obtained in step (2), and glucose accounting for 16% by mass of the core material were mixed, then sintered at 800° C. for 6 hours, and cooled. The cooled material was demagnetized and screened to obtain a finished product.

### Example 8

(1) 50 g of silicon oxide raw material (SiO_{y}, y=1) and 11 g of stabilized lithium metal powder (SLMP) were first uniformly mixed, and then placed into a high-energy merging device to be merged for 1 h, to obtain silicon oxide particles containing the lithium source compound therein;

(2) Under the protection of nitrogen, the silicon oxide particles containing the lithium source compound therein obtained in step (1) were sintered at 1000° C. for 3 hours, then further sintered at 900° C. for 4 hours, followed by cooling to room temperature by passing water, and taken out to obtain a core material; and

(3) The core material obtained in step (2), and glucose accounting for 8% by mass of the core material were mixed, then sintered at 1000° C. for 3 hours, and cooled. The cooled material was demagnetized and screened to obtain a final product.

### Example 9

Example 9 merely differs from Example 1 in that 6 g of LiOH was mixed.

### Comparative Example 1

Comparative Example 1 merely differs from Example 1 in that LiOH was not added and the sintering in step (2) was omitted.

### Comparative Example 2

Comparative Example 2 merely differs from Example 5 in that LiOH was not added and the sintering in step (2) was omitted.

### Comparative Example 3

Comparative Example 3 merely differs from Example 4 in that 250 g of SLMP was added.

### Comparative Example 4

Comparative Example 4 merely differs from Example 1 in that 2.5 g of LiOH was added.

### Tests of X-Ray Diffraction

A Bruker AXS D8 Focus from Germany was used for testing the XRD spectrums of the negative electrode materials prepared in Examples 1-9 and Comparative Examples 1-2, under conditions of CuKα ray, divergence slit 1.0°, antiscattering slit 2.0°, receiving slit 9.6°, voltage 40 KV, current 40 mA, scanning range 10-90°, scanstep 0.01313, continuous scanning mode, scanning time per step 10.2s, calculated wavelength 1.5406 Å. The test results are shown in Table 1.

### Tests of Slurry Storage Performance

An active material, carboxymethyl cellulose, conductive carbon black, and styrene butadiene rubber in a mass ratio of 95.3:1.3:1.5:1.9 were mixed to form a negative electrode slurry with a solid content of 50%, where the active material included a negative electrode material of the lithium ion battery prepared in Examples 1-9 or Comparative Examples 3-4 and graphite in a mass ratio of 9:1. Then, the negative electrode slurry was stood at 25° C. and observed for the changes in gas production, viscosity, flowability, solid content, fineness, and coating. If at least any one of these indicators changed by a range more than 10%, the negative electrode slurry would be considered as unstable, where the change range of the indicator=(test value during standing−initial value)/initial value. The standing time of the slurry maintaining stable was recorded as a stabilized storage time, as shown in Table 1.

### Tests of Electrochemical Performance

Each of the negative electrode materials of the lithium ion battery prepared in Examples 1-9 and Comparative Examples 1-4 as an active material, PI as a binder, and conductive carbon black were mixed and stirred to prepare a slurry, and the slurry was applied on a copper foil, and then subjected to drying and rolling to obtain a negative electrode plate, where a ratio of the active material: the conductive agent: the binder is 85:15:10. In an argon-filled glove box, a simulation batter was assembled, in which a metal lithium plate was used as the counter electrode, PP/PE was used as separator, the electrolytic solution was LiPF6/EC+December+DMC in a volumetric ratio of EC, DEC and DMC of 1:1:1. The electrochemical performance of the battery was tested using the 5V/10 mA Land teste cabinet (LANHE), with a charging and discharging voltage of 1.5V, a charging and discharging rate of 0.1 C, and the test results are shown in Table 1.

TABLE 1

| | Stabilized | First discharge | First | Retention rate | | |
|---|---|---|---|---|---|---|
| | storage time | specific capacity | efficiency | after 50 cycles | x in | |
| | of slurry (h) | (mAh/g) | (%) | (%) | SiOₓ | B/A |
| Example 1 | 86 | 1604 | 90.2 | 89.7 | 0.76 | 1.32 |
| Example 2 | 78 | 1710 | 92.1 | 89.8 | 0.58 | 1.21 |
| Example 3 | 76 | 1690 | 92.8 | 89.4 | 0.98 | 1.01 |
| Example 4 | 82 | 1588 | 93.1 | 90.0 | 0.11 | 1.22 |
| Example 5 | 78 | 1680 | 90.1 | 87.2 | 0.82 | 1.19 |
| Example 6 | 73 | 1700 | 92.4 | 87.4 | 0.65 | 1.05 |
| Example 7 | 96 | 1703 | 90.1 | 87.8 | 0.9 | 4.60 |
| Example 8 | 90 | 1697 | 92.6 | 87.6 | 0.93 | 4.21 |
| Example 9 | 93 | 1690 | 87.2 | 88.1 | 1.3 | 4.5 |
| Comparative | — | 1450 | 76.2 | 84.2 | 0.99 | — |
| Example 1 | | | | | | |
| Comparative | — | 1500 | 77 | 84 | 1.03 | — |
| Example 2 | | | | | | |
| Comparative | 5 | 1250 | 92.3 | 85.5 | 0.08 | 0 |
| Example 3 | | | | | | |
| Comparative | >120 | 1730 | 77.5 | 86.1 | 1.02 | 7.8 |
| Example 4 | | | | | | |

From the test results in Table 1, it can be known that the negative electrode materials according to the present application each have higher first discharge specific capacity, higher first efficiency, and a longer cycle life, compared with the silicon oxide raw material (SiO) and the silicon oxide raw material (SiO) having a carbon coating layer when used as the negative electrode material. Meanwhile, in addition to involving the above good performances, these negative electrode materials also have a high stabilized storage time of slurry. In Examples 1-4, the silicon oxide raw materials having a carbon coating layer, by pre-lithiating, have a longer cycle life, mainly due to a buffering effect of the surface carbon layer. The presence of the surface carbon layer can effectively reduce the pre-lithiation reaction rate, allowing the pre-lithiation reaction to occur more uniformly, thereby forming lithium polysilicate that is distributed more homogeneously.

As shown in Table 1, in Comparative Examples 1 and 2, no pre-lithiation was performed. Thus, the final products contain no lithium polysilicate, thus having no equilibrium level value. In Comparative Example 3, no pre-lithiation was realized. Thus, the final product has an equilibrium level of 0, although its first efficiency is not decreased, the first discharge specific capacity is clearly reduced. In addition, the final product also has a very poor slurry storage performance due to no pre-lithiation. In Comparative Example 4, the final product has an equilibrium level of 7.8, thus has a no reduced first discharge specific capacity and a low first efficiency. In addition, although the final product has a good slurry storage performance, it is still not applicable due to its poor first efficiency, and its excessive stabilized storage time of slurry is also redundant.

The above embodiments are for the purpose of describing the detailed features of the present application, but the present application is not limited to the above detailed features, i.e., the present application is unnecessarily implemented according to the above detailed methods.

The above describes the optional embodiments of the present application in detail, but the present application is not limited to the specific details of the above-mentioned embodiments, and within the scope of the technical concept of the present application, various simple modifications can be made to the technical solutions of the present application.

Additionally, it shall be understood that, the specific technical features described in the above specific embodiments can be combined in any suitable manner unless contradictory. To avoid unnecessary repetition, the present application does not further explain the various possible combinations.

In addition, it is also possible to combine different embodiments of the present application.

What is claimed is:

1. A negative electrode material of a lithium ion secondary battery, wherein the negative electrode material comprises a carbon coating layer and a core layer, the core layer comprises lithium polysilicate and silicon oxide, wherein a mass percentage of the silicon oxide in the negative electrode material is smaller than 20%, and wherein the silicon oxide has a general formula of SiOₓ, wherein 0<x≤1.5.

2. The negative electrode material according to claim 1, wherein the lithium polysilicate comprises any one of or a combination of at least two of 3Li₂O·2SiO₂, Li₂O·2SiO₂, or Li₂O·5SiO₂.

3. The negative electrode material according to claim 1, wherein the negative electrode material satisfies 1.0≤B/A≤4.5, wherein according to a X-ray diffraction spectrum of the negative electrode material, a maximum one of diffraction peaks at 2θ of 18° to 20°, 26° to 27.9°, and 32° to 34° has a peak intensity A; and a maximum one of diffraction peaks at 2θ of 16° to 17°, 22° to 25.9°, and 36° to 38° has a peak intensity B.

4. The negative electrode material according to claim 1, wherein in the core layer, the lithium polysilicate comprises silicon therein.

5. The negative electrode material according to claim 4, wherein the lithium polysilicate is uniformly coated around each cluster of silicon particles.

6. The negative electrode material according to claim 1, wherein the lithium polysilicate is in a crystalline state.

7. The negative electrode material according to claim 1, wherein a mass percentage of the carbon coating layer in the negative electrode material is smaller than 13%.

8. A preparation method of the negative electrode material according to claim 1, the method comprising:
step 1 of mixing a silicon oxide raw material with a lithium source compound, and performing merging in a high-energy merging device, to obtain silicon oxide particles containing the lithium source compound therein;
step 2 of performing a first sintering on the silicon oxide particles containing the lithium source compound therein, which are obtained in the step 1, under a protective atmosphere or vacuum, to obtain a core material; and
step 3 of mixing the core material obtained in the step 2 with a carbon source, and performing a second sintering to obtain the negative electrode material.

9. The preparation method according to claim 8, wherein in the step 1, a molar ratio of the silicon oxide to the lithium source compound is (2.5-9):1.

10. The preparation method according to claim 8, wherein the silicon oxide raw material has a general formula of SiO_{y}, where 0<y≤2, wherein the lithium source compound comprises at least one of lithium hydroxide, lithium amide, lithium carboxylate, lithium hydride, and lithium aluminum hydride, and wherein the protective atmosphere comprises at least one of nitrogen, helium, neon, argon, krypton, and xenon.

11. The preparation method according to claim 8, wherein the first sintering in the step 2 comprises a first stage and a second stage, wherein the first stage is performed at a temperature of 200° C. to 1000° C. for a time period of 1 hour to 3 hours, and the second stage is performed at a temperature of 300° C. to 900° C. for a time period of 4 hours to 6 hours.

12. The preparation method according to claim 8, wherein the carbon source comprises at least one of pitch, coal tar, polythiophene, polyolefin, sugar, polyhydric alcohol, and phenolic resin derivative.

13. The preparation method according to claim 8, wherein a mass ratio of the core material to the carbon source is (0.03-0.15):1.

14. The preparation method according to claim 8, wherein the second sintering in the step 3 is performed at a temperature of 800° C. to 1000° C. for a time period of 3 hours to 6 hours.

15. A preparation method of the negative electrode material according to claim 1, the preparation method comprising:
step 1′ of mixing a silicon oxide raw material having a carbon coating layer with a lithium source compound, and performing merging in a high-energy merging device, to obtain carbon-coated silicon oxide particles containing the lithium source compound therein; and
step 2′ of performing sintering on the carbon-coated silicon oxide particles containing the lithium source compound therein, which are obtained in the step 1′, under a protective atmosphere or vacuum, to obtain the negative electrode material.

16. The preparation method according to claim 15, wherein in the step 1′, a molar ratio of the silicon oxide raw material having a carbon coating layer to the lithium source compound is (2.5-9):1.

17. The preparation method according to claim 15, wherein the silicon oxide raw material has a general formula of SiO_{y}, where 0<y≤2, wherein the lithium source compound comprises at least one of lithium hydroxide, lithium amide, lithium carboxylate, lithium hydride, and lithium aluminum hydride, and wherein the protective atmosphere comprises at least one of nitrogen, helium, neon, argon, krypton, and xenon.

18. The preparation method according to claim 15, wherein the sintering in the step 2′ comprises a first stage and a second stage, wherein the first stage is performed at a temperature of 200° C. to 1000° C. for a time period of 3 hours to 8 hours, and the second stage is performed a temperature of 300° C. to 900° C. for a time period of 4 hours to 10 hours.

19. The preparation method according to claim 15, wherein the silicon oxide raw material having a carbon coating layer has a carbon content of 2 wt % to 10 wt %.

20. The preparation method according to claim 15, after the step 2′, further comprising:
breaking up, screening and demagnetizing the obtained negative electrode material.
